(19) United States
(12) Patent Application Publication
(10) Pub. No.: US 2025/0071472 A1
(43) Pub. Date: Feb. 27, 2025

(54) EAR DOME FOR A HEARING DEVICE

(71) Applicant: GN Hearing A/S, Ballerup (DK)

(72) Inventor: Yu LUAN, Kongens Lyngby (DK)

(73) Assignee: GN Hearing A/S, Ballerup (DK)

(21) Appl. No.: 18/797,528

(22) Filed: Aug. 8, 2024

(30) Foreign Application Priority Data
Aug. 25, 2023 (EP) 23193475.3
Aug. 5, 2024 (EP) 24192859.7

(51) Int. Cl. H04R 1/28; H04R 1/10

(52) U.S. Cl. CPC H04R 1/2873; H04R 1/1016; H04R 1/1058; H04R 2460/09; H04R 2460/13

(57) ABSTRACT

Disclosed is a system comprising a hearing device and an ear dome, and an ear dome configured for sealing an ear canal of a user, the ear dome configured to be attached to a hearing device worn by the user, the ear dome comprising: a hollow central tubular portion configured for providing a fluid connection between the hearing device and the ear canal; wherein a first opening is provided in the tubular portion, the first opening configured to point towards the hearing device, when the ear dome is worn in the user's ear; a first circumferential flange connected to the tubular portion, wherein the first circumferential flange extends radially outwards from the tubular portion; wherein the first circumferential flange curves away from the first opening and forms a concave surface to the tympanic membrane, when the ear dome is worn in its intended position in the user's ear.

### RELATED APPLICATION DATA

This application claims priority to, and the benefit of, European Patent Application No. 23193475.3 filed on Aug. 25, 2023, and European Patent Application No. 24192859.7 filed on Aug. 5, 2024. The entire disclosures of the above applications are expressly incorporated by reference herein.

### FIELD

The present disclosure relates to ear domes. More specifically, the disclosure relates to an ear dome configured for sealing an ear canal of a user. The ear dome is configured to be attached to a hearing device worn by the user. The ear dome comprising a hollow central tubular portion configured for providing a fluid connection between the hearing device and the ear canal.

### BACKGROUND

Occlusion effect is an uncomfortable experience for the user and may happen when the ear canal is occluded, e.g. blocked, e.g., by a hearing device. The occlusion effect can be mitigated in different ways.

In prior art, the occlusion effect may be mitigated either by providing a vent in the hearing device, or by performing active occlusion cancelation. However, the usefulness of having a vent comes at a cost, because of reduced directivity and reduced noise reduction, and as a result the user may experience reduced speech intelligibility in loud and noisy situations. Regarding active occlusion cancelation, a disadvantage of this is that active occlusion cancellation uses battery power because the active occlusion cancelation requires signal processing in the hearing device.

An ear dome in a hearing device may play a role in the occlusion effect.

Thus, there is a need for an improved ear dome for a hearing device.

### SUMMARY

Disclosed is an ear dome configured for sealing an ear canal of a user. The ear dome is configured to be attached to a hearing device worn by the user. The ear dome comprising a hollow central tubular portion configured for providing a fluid connection between the hearing device and the ear canal. A first opening is provided in the tubular portion. The first opening being configured to point towards the hearing device, when the ear dome is worn in its intended position in the user's ear. The ear dome comprising a first circumferential flange connected to the tubular portion. The first circumferential flange extends radially outwards from the tubular portion. The first circumferential flange curves away from the first opening and forms a concave surface to the tympanic membrane, when the ear dome is worn in its intended position in the user's ear.

The ear dome may also be referred to as an ear gel or ear plug. The ear dome is configured to be attached and detached from the hearing device. The ear dome may be exchanged by the user of the hearing device, when the ear dome is broken, dirty or the like. The ear dome may be made of a soft, resilient material, such as soft plastic, rubber, silicone or the like. The ear dome is configured to be pleasant for the user to wear, at least partly, in the ear canal. If the ear dome is too hard, it will be unpleasant for the user for wear the ear dome. If the ear dome is too soft, the ear dome may not provide a sufficient sealing of the ear canal. The ear dome is configured for sealing the ear canal of the user wearing the ear dome and the hearing device. Sealing of the ear canal is relevant for providing that the ear dome can mitigate an occlusion effect in the user's ear, when the ear dome is worn in its intended position in the user's ear. The occlusion effect may be mitigated due to the ear dome providing a first sound pressure being in anti-phase to a second sound pressure provided by the ear canal walls of the user's ear, when the ear dome is worn in its intended position in the user's ear.

Occlusion effect is an uncomfortable experience for the user and may happen when the ear canal is occluded, e.g. blocked, e.g., by a hearing device. The occlusion effect can be mitigated in different ways.

In prior art, the occlusion effect is mitigated either by providing a vent in the hearing device, or by performing active occlusion cancelation. However, the usefulness of having a vent comes at a cost, because of reduced directivity and reduced noise reduction, and as a result the user may experience reduced speech intelligibility in loud and noisy situations. Regarding active occlusion cancelation, a disadvantage of this is that active occlusion cancellation uses battery power because the active occlusion cancelation requires signal processing in the hearing device.

The present ear dome is configured to be acoustically sealed. The present ear dome is configured for avoiding that air/sound leaks. The present ear dome may not comprise any venting holes or any vent, i.e. the ear dome may lack venting holes or a vent. Thus, the present ear dome is configured for mitigating the occlusion effect without providing a vent in the hearing device. Thus, venting holes are not necessary in the present ear dome because the occlusion effect is mitigated due to the acoustic sealing and due to the ear dome providing a first sound pressure being in anti-phase to a second sound pressure provided by the ear canal walls of the user's ear, when the ear dome is worn in its intended position in the user's ear.

The present ear dome has been invented because the inventor has realized that closed ear domes in hearing devices play a significant role in the occlusion effect. The inventor has realized that changing the dome design to reduce the occlusion effect will provide positive effect to people's wearing comfort.

The present ear dome is configured to be placed in the outer half of the external auditory canal, i.e. in the part pointing towards the surroundings. The ear dome is configured to be placed in the cartilaginous part of the external auditory canal. Thus, the ear dome is not configured for deep placement, i.e. not configured to be placed in the bony part of external auditory canal, since there may be no vibration of the ear canal wall in this bony area.

For the present ear dome, the occlusion effect may be mitigated due to the ear dome providing a first sound pressure being in anti-phase to a second sound pressure provided by the ear canal walls of the user's ear, when the ear dome is worn in its intended position in the user's ear. Therefore, the ear dome is configured to be arranged in the outer half of the external auditory canal, such as in the cartilaginous part of the external auditory canal, for ensuring that the ear canal vibrates for mitigating the occlusion effect.

It is an advantage of the present ear dome that it mitigates the occlusion effect. The ear dome mitigates the occlusion effect by providing volume velocity as well as sound pressure to the ear canal that is in anti-phase to the volume velocity contributed by the ear canal walls. Thus, the occlusion effect may be mitigated because the ear dome provides a first sound pressure being in anti-phase to a second sound pressure provided by the ear canal walls of the user's ear, when the ear dome is worn in its intended position in the user's ear.

When a user is wearing an ear dome in the ear canal, bone conducted vibration may excite the ear canal walls and may therefore compress the ear dome, because bone conducted vibration cause the ear canal wall to expand and contract in the radial direction, which in turn causes the ear canal wall to change the force it exerts on the ear dome making it deform, or extended, in the axial direction.

The bone-conducted sound pressure in an occluded ear canal can be calculated as:

$$\hat{p} = \frac{{\hat{q}}_{EC} + {\hat{q}}_{DOME}}{j ω ( {C}_{Air} + {C}_{TM} )} , \qquad ( 1 )$$

where C_{Air} is the compliance of air in the occluded ear canal, C_{TM} is the tympanic membrane's compliance, \hat{q}_{EC} is the volume velocity of the ear canal wall's vibration, and \hat{q}_{Dome} is the volume velocity of the dome surface's vibration. The \hat{q}_{Dome} can be obtained as:

$${\hat{q}}_{Dome} = \int vdA , \qquad ( 2 )$$

where v is the vibration velocity, and A is the area.

To explain the mitigation, we rewrite the eq. (1) to be:

$$\hat{p} = \qquad ( 3 )$$

$$\frac{{\hat{q}}_{EC} + {\hat{q}}_{Dome}}{j ω ( {C}_{Air} + {C}_{TM} )} = \frac{{\hat{q}}_{EC}}{j ω ( {C}_{Air} + {C}_{TM} )} + \frac{{\hat{q}}_{Dome}}{j ω ( {C}_{Air} + {C}_{TM} )} = {\hat{p}}_{EC} + {\hat{p}}_{Dome} ,$$

where \hat{p}_{EC} is the ear canal contributed sound, and \hat{p}_{Dome} is the dome contributed sound. The goal is to make \hat{p}_{Dome} approximate −\hat{p}_{EC} as closely as possible in order to minimize \hat{p}.

It is an advantage of the present ear dome that it provides sound pressure in the ear canal in anti-phase to the sound induced by the ear canal walls. When the vibration from the ear canal walls compresses the dome, the main dome medial surface vibrates in the z-axis direction, and therefore, provide volume velocity as well sound pressure in anti-phase to the sound contributed by the ear canal walls. The z-axis direction is the horizontal direction towards the outside of the ear. The z-axis direction is parallel to the ear-to-ear axis.

The ear dome comprises a hollow central tubular portion configured for providing a fluid connection between the hearing device and the ear canal. The fluid connection is for allowing sound to pass through the ear dome between the hearing device, placed outside the ear in the surroundings, and the inner part if the ear canal. The hollow central tubular portion may be a hollow tubular portion. The hollow central tubular portion may be arranged along a first direction of the ear dome.

A first opening is provided in the tubular portion. The first opening is configured to point towards the hearing device, when the ear dome is worn in its intended position in the user's ear.

The ear dome comprises a first circumferential flange connected to the tubular portion. The first circumferential flange extends radially outwards from the tubular portion.

The first circumferential flange curves away from the first opening and forms a concave surface to the tympanic membrane, when the ear dome is worn in its intended position in the user's ear.

Thus, the first circumferential flange of the ear dome according to some embodiments curves in an opposite direction relative to the flange of prior art ear domes.

It is an advantage that the ear dome mitigates the occlusion effect due to the direction of the curvature of the flange of the ear dome.

The hollow central tubular portion may comprise a first end and a second end. The first end and the second end of the tubular portion are arranged opposite to each other. The first opening may be provided in the first end of the tubular portion.

The first circumferential flange may be a projecting rim, collar, or part on the tubular portion. The first circumferential flange may provide that the ear dome maintains its position in the ear canal when inserted in the ear canal.

The tubular portion may extend in a first direction between the first end and the second end. The first circumferential flange may curve away from the first opening in a second direction. The second direction may be about between 45 degrees to 90 degrees relative to the first direction, such as about between 55 degrees to 90 degrees, such as about between 65 degrees to 90 degrees, such as about between 75 degrees to 90 degrees, such as about between 85 degrees to 90 degrees, such as about 90 degrees. Thus, the second direction may be perpendicular to the first direction.

The ear dome may be manufactured in a material. The thickness of the material may be between about 0.1 mm to 0.5 mm, such as 0.1 mm to 0.4 mm. The thickness of the material may maximally be 0.4 mm. The thickness of the material may be between about 0.1 mm and 0.2 mm. The dome may be stiffened by stiffening ribs to avoid resonance below 1k Hz. The occlusion effect mitigation may be about 9-14 dB from 100-1k Hz.

The material of the ear dome may be a soft, resilient material, such as soft plastic, rubber, silicone or the like. The material may e.g. be a silicone material having a hardness property in a range of Shore A 20 to Shore A 60, such as Shore A 30 to Shore A 50, such as Shore A 40.

Due to the thickness and/or hardness of the ear dome material, the vibrations from the ear canal may be transmitted to the ear dome, and thus the ear dome may provide to mitigate the occlusion effect.

In prior art ear domes, the material of the ear dome may be thicker and/or harder than the present ear dome. Thus, prior art ear domes may not absorb the vibrations from the ear canal and translate the vibration into an anti-phase sound to the ear canal, and thereby the prior art ear domes may not mitigate the occlusion effect.

The curvature of the dome may be optimized to provide an efficient sound radiation. The prior art ear domes are not optimized in shape, and they either increase the occlusion effect or are not able to mitigate the occlusion effect.

According to an aspect, disclosed is a system comprising an ear dome according to claim 1 and a hearing device. The hearing device may comprise an output transducer, such as a receiver or speaker, and the ear dome may be attached to a tower of the output transducer.

In some embodiments, the ear dome comprises a reinforcement portion configured for ensuring that the ear dome maintains the first circumferential flange curving away from the first opening and forming the concave surface to the tympanic membrane. In particular, the ear dome should maintain the first circumferential flange curving away from the first opening and forming the concave surface to the tympanic membrane, when ear dome is inserted and/or retracted from ear canal by user, and/or when the ear dome is arranged in the ear canal. If the ear dome does not have a reinforcement portion, there is a risk that the first circumferential flange will flip back, when the ear dome is inserted in the ear canal, because the flange is pointing towards the insertion direction in the ear canal. In such case, the flange would thereby not be forming the concave surface to the tympanic membrane.

In some embodiments, the reinforcement portion comprises a second circumferential flange connected to the first circumferential flange, and wherein the second circumferential flange extends radially outwards from the first circumferential flange. Thus, the second circumferential flange may be arranged at the circumference of the first circumferential flange. The second circumferential flange may have a diameter which is smaller than the diameter of the first circumferential flange. The diameter of the second circumferential flange may be as small as possible. The diameter of the second circumferential flange may be about below 10% of the diameter of the first circumferential flange.

It is an advantage that the second circumferential flange is as small as possible as this minimizes the reduction of vibrations of the first circumferential flange, i.e. minimize the reduction of the vibrations which is to absorb the vibrations from the ear canal and/or mitigate the occlusion effect. This as e.g. vibrations of the second circumferential flange may cancel out the vibrations of the first circumferential flange if the effective area of the second circumferential flange is the same or larger than the effective area of the first circumferential flange (given that the first and second circumferential flange has the same material properties, etc.). The effective area may be the vibrating surface of the ear dome.

In some embodiments, the second circumferential flange curves towards the first opening and forms a convex surface to the tympanic membrane, when the ear dome is worn in its intended position in the user's ear. Thus, the second circumferential flange curves in an opposite direction relative to the first circumferential flange. It is an advantage of the second circumferential flange that it may prevent the first circumferential flange from flipping back, when the ear dome is inserted in the ear canal, because the curve of the second circumferential flange is opposite to the insertion direction of the ear dome in the ear canal.

In some embodiments, the reinforcement portion comprises a rib provided in an inner surface of the first circumferential flange. The rib may be comprise one or more ribs. The one or more ribs may be a straight piece of material extending across the inner space defined the first circumferential flange, and each end of the rib(s) may be connected in the inner surface of the first circumferential flange. An outer surface of the first circumferential flange may point towards the ear canal walls.

In some embodiments, the rib is provided in the concave surface formed by the first circumferential flange. The rib may be comprise one or more ribs. The one or more ribs may be a straight piece of material extending across the concave surface defined the first circumferential flange, and each end of the rib(s) may be connected in the concave surface of the first circumferential flange.

In some embodiments, the reinforcement portion comprises a foam provided in an inner surface of the first circumferential flange. The foam may have material properties which provides that the foam has a hardness value and/or a stiffness value which provides, e.g. is high enough, that the ear dome can maintain its shape when ear dome is inserted in and/or retracted from the ear canal. The foam material may have properties which does not affect, or only has a limited effect, on the acoustics of the ear dome. The foam may fill up the entire space defined by the inner surface of the first circumferential flange, or the foam may fill part of the space defined by the inner surface of the first circumferential flange.

In some embodiments, the foam is provided in the concave surface formed by the first circumferential flange. The foam may fill up the entire space defined by the concave surface of the first circumferential flange, or the foam may fill part of the space defined by the concave surface of the first circumferential flange.

In some embodiments, a second opening is provided in the tubular portion, the second opening being configured to point towards the tympanic membrane, when the ear dome is worn in its intended position in the user's ear; and wherein the second opening is provided in the concave surface formed by the first circumferential flange. The second opening may be provided in the second end of the tubular portion.

In some embodiments, the first circumferential flange is connected at the tubular portion between the first opening and the second opening. The first circumferential flange may be connected, attached, provided, moulded etc at the tubular portion.

In some embodiments, the first circumferential flange is connected at the first opening of the tubular portion. The first circumferential flange may be connected, attached, provided, moulded etc at the first opening of the tubular portion.

In some embodiments, the first circumferential flange is connected at the second opening of the tubular portion. The first circumferential flange may be connected, attached, provided, moulded etc at the second opening of the tubular portion.

In some embodiments, the inner diameter of the concave surface of the first circumferential flange is about between 1 mm-4 mm, and wherein the outer diameter of the concave surface of the first circumferential flange is about between 6 mm-12 mm.

The inner diameter of the concave surface of the first circumferential flange may be about between 1 mm-4 mm, such as 1 mm-3 mm, such as 1 mm-2 mm, such as about 1.5 mm to about 1.6 mm, such as 1.54 mm.

The outer diameter of the concave surface of the first circumferential flange may have different sizes depending on whether the ear dome is a so-called small, medium or large ear dome. Users have different ear sizes, and therefore ear domes may be provided in different sizes to fit all users' ears. Thus, the outer diameter of the concave surface of the first circumferential flange of the ear dome may be about between 4 mm-13 mm, such as 5 mm-12 mm, such as about 5 mm for a small ear dome, such as about 7.6 mm for a medium ear dome, such as about 10 mm for a large ear dome of a first type, and such as about 11.5 mm for a large ear dome of a second type.

It is an advantage that the outer diameter of the concave surface of the first circumferential flange of the ear dome is large compared to the inner diameter of the concave surface of the first circumferential flange, because the larger difference there are between these two diameters, the better the dome vibrates, which will mitigate the occlusion effect.

The inner diameter of the concave surface of the first circumferential flange may correspond to or be the same as the outer diameter of the first opening of the tubular portion.

The diameter of the first opening of the tubular portion may be the same for all types of receivers. Thus, for a low power, medium power and high power receiver, the diameter of the first opening of the tubular portion may be the same. Alternatively, the diameter of the first opening of the tubular portion may be different for different types of receivers.

The first opening of the tubular portion may have an inner diameter of about 1.5 mm to about 1.6 mm, such as 1.54 mm.

The first opening of the tubular portion may have an outer diameter of about 1.75 mm to about 1.95 mm, such as 1.85 mm.

Thus, for a large ear dome, the ratio between the outer diameter of the concave surface of the first circumferential flange and the inner diameter of the concave surface of the first circumferential flange may be about 11.5 mm/1.85 mm=6.2.

For a small ear dome, the ratio between the outer diameter of the concave surface of the first circumferential flange and the inner diameter of the concave surface of the first circumferential flange may be about 5 mm/1.85 mm=2.7.

Thus, the ratio between the outer diameter of the concave surface of the first circumferential flange and the inner diameter of the concave surface of the first circumferential flange may preferably be more than 2.7 for ensuring a high vibration of the dome, which will mitigate the occlusion effect.

In some embodiments, the ear dome is configured to be acoustically sealed for avoiding that air/sound leaks, and/or wherein the ear dome lacks venting holes or a vent.

In some embodiments, the ear dome is configured to be placed in the outer half of the external auditory canal pointing towards the surroundings, and/or wherein the ear dome is configured to be placed in the cartilaginous part of the external auditory canal, and/or wherein the ear dome is not configured to be placed in the bony part of external auditory canal.

In some embodiments, the ear dome is configured for mitigating an occlusion effect in the user's ear, when the ear dome is worn in its intended position in the user's ear.

In some embodiments, the occlusion effect is mitigated due to the ear dome providing a first sound pressure being in anti-phase to a second sound pressure provided by the ear canal walls of the user's ear, when the ear dome is worn in its intended position in the user's ear.

In an embodiment, a hearing device is configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, such as a binaural hearing aid system.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are Behind-the-Ear (BTE) hearing device, Receiver-in-Canal (RIC) hearing device, Receiver-in-Ear (RIE) hearing device or Microphone-and-Receiver-in-Ear (MaRIE) hearing device. These devices may comprise a BTE unit configured to be worn behind the ear of the user and an in the ear (ITE) unit configured to be inserted partly or fully into the user's ear canal. Generally, the BTE unit may comprise at least one input transducer, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprise in the ITE unit, which is coupled to the BTE unit via a connector cable or wire configured for transferring electric signals between the BTE and ITE units.

Some of these form factors are In-the-Ear (ITE) hearing device, Completely-in-Canal (CIC) hearing device or Invisible-in-Canal (IIC) hearing device. These hearing devices may comprise an ITE unit, wherein the ITE unit may comprise at least one input transducer, a power source, a processing unit and an output transducer. These form factors may be custom devices, meaning that the ITE unit may comprise a housing having a shell made from a hard material, such as a hard polymer or metal, or a soft material such as a rubber-like polymer, molded to have an outer shape conforming to the shape of the specific user's ear canal.

Some of these form factors are earbuds, on the ear headphones or over the ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHZ, preferably a wavelength between 900 MHz and 6 GHZ. The first frequency may be 902 MHz to 928 MHz. The first frequency may be 2.4 to 2.5 GHZ. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

The present disclosure relates to different aspects including the ear dome, the hearing device and the system described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIGS. 1a, 1b and 1c schematically illustrate an exemplary prior art ear dome 100 attached to a hearing device 200.

FIG. 2a schematically illustrates an exemplary prior art ear dome 100 attached to a hearing device 200.

FIG. 2b schematically illustrates an exemplary ear dome 2 according to some embodiments.

FIG. 3 schematically illustrates an exemplary ear dome 2 attached to a hearing device 6, and also the occlusion effect mitigation.

FIGS. 4a and 4b schematically illustrates exemplary ear domes 2 each comprising a reinforcement portion 18.

FIG. 5 schematically illustrates examples of the various diameters of the ear dome 2.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

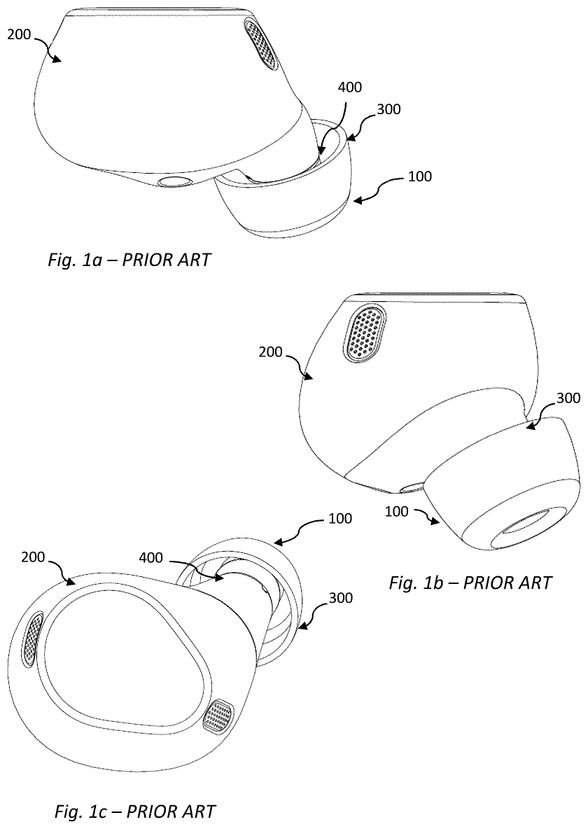

FIGS. 1a, 1b and 1c schematically illustrate an exemplary prior art ear dome 100 attached to a hearing device 200. The ear dome 100 has a flange 300 which curves towards a first opening 400 and forms a convex surface to the tympanic membrane, when the ear dome 100 is worn in its intended position in the user's ear.

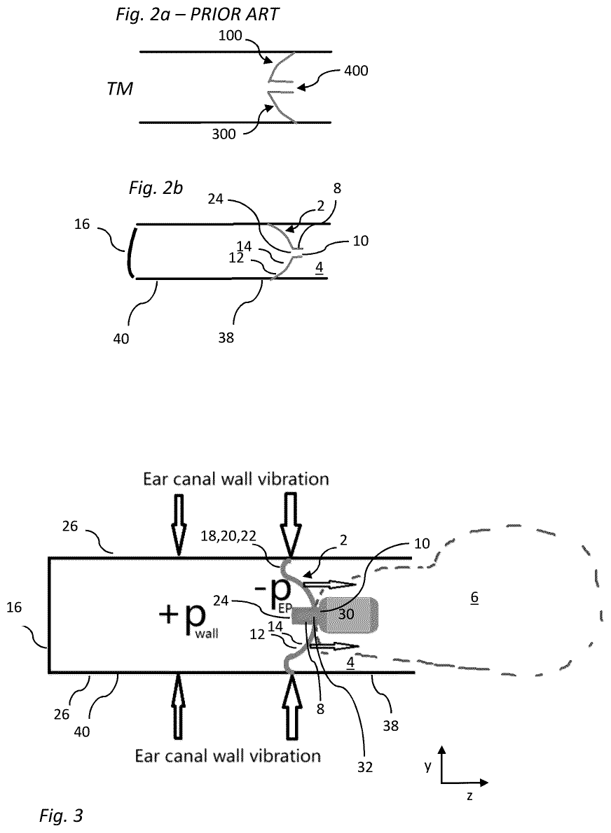

FIG. 2a schematically illustrates an exemplary prior art ear dome 100 attached to a hearing device (not shown). The ear dome 100 has a flange 300 which curves towards a first opening 400 and forms a convex surface to the tympanic membrane (TM), when the ear dome 100 is worn in its intended position in the user's ear.

FIG. 2b schematically illustrates an exemplary ear dome 2 according to some embodiments. The ear dome 2 configured for sealing an ear canal 4 of a user. The ear dome 2 is configured to be attached to a hearing device (not shown) worn by the user. The ear dome 2 comprises a hollow central tubular portion 8 configured for providing a fluid connection between the hearing device and the ear canal 4. A first opening 10 is provided in the tubular portion 8. The first opening 10 is configured to point towards the hearing device, when the ear dome 2 is worn in its intended position in the user's ear. The ear dome 2 comprises a first circumferential flange 12 connected to the tubular portion 8. The first circumferential flange 12 extends radially outwards from the tubular portion 8. The first circumferential flange 12 curves away from the first opening 10 and forms a concave surface 14 to the tympanic membrane 16, when the ear dome 2 is worn in its intended position in the user's ear.

Thus, the first circumferential flange 12 of the ear dome 2 according to some embodiments curves in an opposite direction relative to the flange 300 of the prior art ear dome 100.

A second opening 24 is provided in the tubular portion 8, the second opening 24 being configured to point towards the tympanic membrane, when the ear dome 2 is worn in its intended position in the user's ear; and wherein the second opening 24 is provided in the concave surface 14 formed by the first circumferential flange 12.

The first circumferential flange 12 is connected at the second opening 24 of the tubular portion 8.

The ear dome 2 is configured to be placed in the outer half of the external auditory canal, i.e. in the part pointing towards the surroundings, which is the right part of the ear canal shown. The ear dome 2 is configured to be placed in the cartilaginous part 38 of the external auditory canal, which is the right part of the ear canal shown. Thus, the ear dome 2 is not configured for deep placement, i.e. not configured to be placed in the bony part 40 of external auditory canal, which is the left part of the ear canal shown, i.e. pointing towards the tympanic membrane 16.

FIG. 3 schematically illustrates an exemplary ear dome 2. The ear dome 2 configured for sealing an ear canal 4 of a user. The ear dome 2 is configured to be attached to a hearing device 6 worn by the user. The ear dome 2 comprises a hollow central tubular portion 8 configured for providing a fluid connection between the hearing device 6 and the ear canal 4. A first opening 10 is provided in the tubular portion 8. The first opening 10 is configured to point towards the hearing device 6, when the ear dome 2 is worn in its intended position in the user's ear. The ear dome 2 comprises a first circumferential flange 12 connected to the tubular portion 8. The first circumferential flange 12 extends radially outwards from the tubular portion 8. The first circumferential flange 12 curves away from the first opening 10 and forms a concave surface 14 to the tympanic membrane 16, when the ear dome 2 is worn in its intended position in the user's ear.

The ear dome 2 comprises a reinforcement portion 18 configured for ensuring that the ear dome 2 maintains the first circumferential flange 12 curving away from the first opening 10 and forming the concave surface 14 to the tympanic membrane 16.

The reinforcement portion 18 comprises a second circumferential flange 20 connected to the first circumferential flange 12, and wherein the second circumferential flange 20 extends radially outwards from the first circumferential flange 12.

The second circumferential flange 20 curves towards the first opening 10 and forms a convex surface 22 to the tympanic membrane 16, when the ear dome 2 is worn in its intended position in the user's ear.

A second opening 24 is provided in the tubular portion 8, the second opening 24 being configured to point towards the tympanic membrane 16, when the ear dome 2 is worn in its intended position in the user's ear.

The first circumferential flange 12 is connected at the first opening 10 of the tubular portion 8.

The inner diameter of the concave surface 14 of the first circumferential flange 12 may be about between 1 mm-4 mm. The outer diameter of the concave surface 14 of the first circumferential flange 12 may be about between 6 mm-12 mm.

When a user is wearing an ear dome 2 in the ear canal 4, bone conducted vibration may excite the ear canal walls 26 and may therefore compress the ear dome 2, because bone conducted vibration cause the ear canal wall 26 to expand and contract in the radial direction, which in turn causes the ear canal wall 26 to change the force it exerts on the ear dome 2 making it deform, or extended, in the axial direction. The radial direction is indicated as the vertical direction, y-direction, in FIG. 3. The axial direction is indicated as the horizontal direction, z-direction, in FIG. 3.

It is an advantage of the present ear dome 2 that it provides sound pressure in the ear canal 4 in anti-phase to the sound induced by the ear canal walls 26. When the vibration from the ear canal walls 26 compresses the dome 2, the main dome medial surface vibrates in the z-axis direction, and therefore, provide volume velocity as well sound pressure in anti-phase to the sound contributed by the ear canal walls 26. The z-axis direction is the horizontal direction towards the outside of the ear. The z-axis direction is parallel to the ear-to-ear axis.

The ear dome 2 is configured for mitigating an occlusion effect in the user's ear, when the ear dome 2 is worn in its intended position in the user's ear.

The occlusion effect is mitigated due to the ear dome 2 providing a first sound pressure −pₑₚ being in anti-phase to a second sound pressure +p_{wall} provided by the ear canal walls 26 of the user's ear, when the ear dome 2 is worn in its intended position in the user's ear.

FIG. 3 also schematically illustrates a system comprising an ear dome 2 according to claim 1 and a hearing device 6. The hearing device 6 comprises an output transducer 30, such as a receiver or speaker, and the ear dome 2 may be attached to a tower 32 of the output transducer 30.

The ear dome 2 is configured to be placed in the outer half of the external auditory canal, i.e. in the part pointing towards the surroundings, which is the right part of the ear canal 26. The ear dome 2 is configured to be placed in the cartilaginous part 38 of the external auditory canal, which is the right part of the ear canal 26. Thus, the ear dome 2 is not configured for deep placement, i.e. not configured to be placed in the bony part 40 of external auditory canal, which is the left part of the ear canal 26, i.e. pointing towards the tympanic membrane 16.

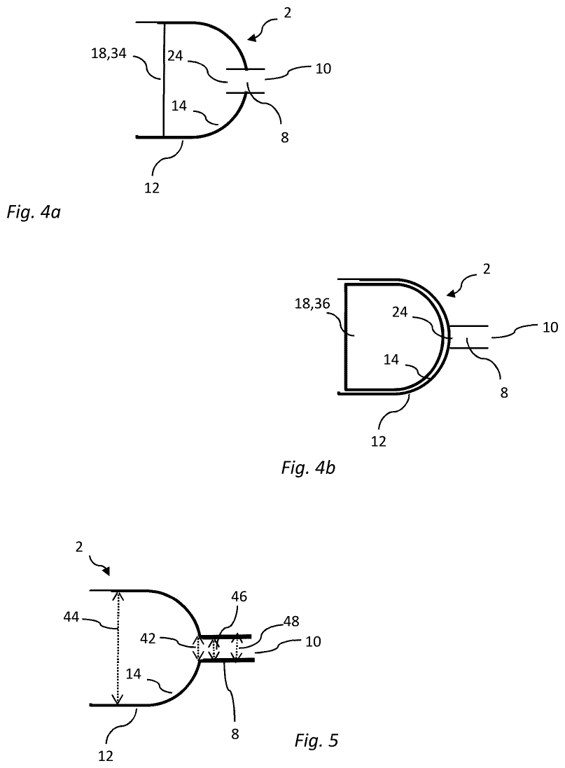

FIGS. 4a and 4b schematically illustrates an exemplary ear dome 2. The ear dome 2 is configured for sealing an ear canal (not shown) of a user. The ear dome 2 is configured to be attached to a hearing device (not shown) worn by the user. The ear dome 2 comprises a hollow central tubular portion 8 configured for providing a fluid connection between the hearing device and the ear canal. A first opening 10 is provided in the tubular portion 8. The first opening 10 is configured to point towards the hearing device, when the ear dome 2 is worn in its intended position in the user's ear. The ear dome 2 comprises a first circumferential flange 12 connected to the tubular portion 8. The first circumferential flange 12 extends radially outwards from the tubular portion 8. The first circumferential flange 12 curves away from the first opening 10 and forms a concave surface 14 to the tympanic membrane, when the ear dome 2 is worn in its intended position in the user's ear.

The ear dome 2 comprises a reinforcement portion 18 configured for ensuring that the ear dome 2 maintains the first circumferential flange 12 curving away from the first opening 10 and forming the concave surface 14 to the tympanic membrane.

In FIG. 4a, the reinforcement portion 18 comprises a rib 34 provided in the concave surface 14, e.g. an inner surface, formed by the first circumferential flange 12. The rib 34 may comprise one or more ribs 34. The one or more ribs 34 may be a straight piece of material extending across the concave surface, e.g. inner space defined the first circumferential flange 12, and each end of the rib(s) 34 may be connected in the concave surface, e.g. the inner surface of the first circumferential flange 12.

The first circumferential flange 12 is connected at the tubular portion 8 between the first opening 10 and the second opening 24.

In FIG. 4b, the reinforcement portion comprises a foam 36 provided in the concave surface 14, e.g. an inner surface, formed by the first circumferential flange 12. The foam 36 may fill up the entire space defined by the concave surface, e.g. inner surface of the first circumferential flange 12, or the foam may fill part of the space defined by the concave surface, e.g. inner surface of the first circumferential flange 12.

The first circumferential flange 12 is connected at the second opening 24 of the tubular portion 8.

FIG. 5 schematically illustrates examples of the various diameters of the ear dome 2. The ear dome 2 is configured for sealing an ear canal (not shown) of a user. The ear dome 2 is configured to be attached to a hearing device (not shown) worn by the user. The ear dome 2 comprises a hollow central tubular portion 8 configured for providing a fluid connection between the hearing device and the ear canal. A first opening 10 is provided in the tubular portion 8. The first opening 10 is configured to point towards the hearing device, when the ear dome 2 is worn in its intended position in the user's ear. The ear dome 2 comprises a first circumferential flange 12 connected to the tubular portion 8. The first circumferential flange 12 extends radially outwards from the tubular portion 8. The first circumferential flange 12 curves away from the first opening 10 and forms a concave surface 14 to the tympanic membrane, when the ear dome 2 is worn in its intended position in the user's ear.

The inner diameter 42 of the concave surface 14 of the first circumferential flange 12 may be about between 1 mm-4 mm, such as 1 mm-3 mm, such as 1 mm-2 mm, such as about 1.5 mm to about 1.6 mm, such as 1.54 mm.

The outer diameter 44 of the concave surface 14 of the first circumferential flange 12 is about between 6 mm-12 mm.

The inner diameter 42 of the concave surface 14 of the first circumferential flange 12 may correspond to or be the same as the outer diameter 48 of the first opening 10 of the tubular portion 8.

The first opening 10 of the tubular portion 8 may have an inner diameter 46 of about 1.5 mm to about 1.6 mm, such as 1.54 mm.

The first opening 10 of the tubular portion 8 may have an outer diameter 48 of about 1.75 mm to about 1.95 mm, such as 1.85 mm.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### Items:

1. An ear dome configured for sealing an ear canal of a user, the ear dome is configured to be attached to a hearing device worn by the user, the ear dome comprising:
a hollow central tubular portion configured for providing a fluid connection between the hearing device and the ear canal;
wherein a first opening is provided in the tubular portion, the first opening being configured to point towards the hearing device, when the ear dome is worn in its intended position in the user's ear;
a first circumferential flange connected to the tubular portion, wherein the first circumferential flange extends radially outwards from the tubular portion;
wherein the first circumferential flange curves away from the first opening and forms a concave surface to the tympanic membrane, when the ear dome is worn in its intended position in the user's ear.

2. The ear dome according to any of the preceding items, wherein the ear dome comprises a reinforcement portion configured for ensuring that the ear dome maintains the first circumferential flange curving away from the first opening and forming the concave surface to the tympanic membrane.

3. The ear dome according to any of the preceding items, wherein the reinforcement portion comprises a second circumferential flange connected to the first circumferential flange, and wherein the second circumferential flange extends radially outwards from the first circumferential flange.

4. The ear dome according to the preceding item, wherein the second circumferential flange curves towards the first opening and forms a convex surface to the tympanic membrane, when the ear dome is worn in its intended position in the user's ear.

5. The ear dome according to any of the preceding items, wherein the reinforcement portion comprises a rib provided in an inner surface of the first circumferential flange.

6. The ear dome according to the preceding item, wherein the rib is provided in the concave surface formed by the first circumferential flange.

7. The ear dome according to any of the preceding items, wherein the reinforcement portion comprises a foam provided in an inner surface of the first circumferential flange.

8. The ear dome according to the preceding item, wherein the foam is provided in the concave surface formed by the first circumferential flange.

9. The ear dome according to any of the preceding items, wherein a second opening is provided in the tubular portion, the second opening being configured to point towards the tympanic membrane, when the ear dome is worn in its intended position in the user's ear; and wherein the second opening is provided in the concave surface formed by the first circumferential flange.

10. The ear dome according to any of the preceding items, wherein the first circumferential flange is connected at the tubular portion between the first opening and the second opening.

11. The ear dome according to any of the preceding items, wherein the first circumferential flange is connected at the first opening of the tubular portion.

12. The ear dome according to any of the preceding items, wherein the first circumferential flange is connected at the second opening of the tubular portion.

13. The ear dome according to any of the preceding items, wherein the inner diameter of the concave surface of the first circumferential flange is about between 1 mm-4 mm, and wherein the outer diameter of the concave surface of the first circumferential flange is about between 6 mm-12 mm.

14. The ear dome according to any of the preceding items, wherein the ear dome is configured to be acoustically sealed for avoiding that air/sound leaks, and/or wherein the ear dome lacks venting holes or a vent.

15. The ear dome according to any of the preceding items, wherein the ear dome is configured to be placed in the outer half of the external auditory canal pointing towards the surroundings, and/or wherein the ear dome is configured to be placed in the cartilaginous part of the external auditory canal, and/or wherein the ear dome is not configured to be placed in the bony part of external auditory canal.

16. The ear dome according to any of the preceding items, wherein the ear dome is configured for mitigating an occlusion effect in the user's ear, when the ear dome is worn in its intended position in the user's ear.

17. The ear dome according to any of the preceding items, wherein the occlusion effect is mitigated due to the ear dome providing a first sound pressure being in anti-phase to a second sound pressure provided by the ear canal walls of the user's ear, when the ear dome is worn in its intended position in the user's ear.

18. A system comprising an ear dome according to item 1 and a hearing device.

### LIST OF REFERENCES

2 ear dome
4 ear canal
6 hearing device
8 hollow central tubular portion
10 first opening
12 first circumferential flange
14 concave surface
16 tympanic membrane
18 reinforcement portion
20 second circumferential flange
22 convex surface
24 second opening
26 ear canal walls of user's ear
30 output transducer
32 tower of the output transducer
34 rib
36 foam
38 cartilaginous part of the external auditory canal
40 bony part of the external auditory canal
42 inner diameter of the concave surface of the first circumferential flange
44 outer diameter of the concave surface of the first circumferential flange
46 inner diameter of the first opening of the tubular portion
48 outer diameter of the first opening of the tubular portion
100 prior art ear dome
200 hearing device for prior art ear dome
300 flange of prior art ear dome
400 first opening of prior art ear dome
−pₑₚ first sound pressure
+p_{wall} second sound pressure

1. An ear dome configured to seal an ear canal of a user, the ear dome configured to be attached to a hearing device, the ear dome comprising:
a tubular portion configured to provide a fluid connection between the hearing device and the ear canal, wherein the tubular portion comprises a first opening, the first opening being configured to point towards the hearing device when the ear dome is worn by the user; and
a first circumferential flange connected to the tubular portion, wherein the first circumferential flange extends radially outwards from the tubular portion;
wherein the first circumferential flange curves away from the first opening and forms a concave surface facing the tympanic membrane, when the ear dome is worn by the user.

2. The ear dome according to claim 1, further comprising a reinforcement portion.

3. The ear dome according to claim 2, wherein the reinforcement portion comprises a second circumferential flange connected to the first circumferential flange, and wherein the second circumferential flange extends radially outwards from the first circumferential flange.

4. The ear dome according to claim 3, wherein the second circumferential flange curves towards the first opening and forms a convex surface with respect to the tympanic membrane, when the ear dome is worn by the user.

5. The ear dome according to claim 2, wherein the reinforcement portion comprises a rib at an inner surface of the first circumferential flange.

6. The ear dome according to claim 5, wherein the rib is at the concave surface formed by the first circumferential flange.

7. The ear dome according to claim 2, wherein the reinforcement portion comprises a foam at an inner surface of the first circumferential flange.

8. The ear dome according to claim 7, wherein the foam is at the concave surface formed by the first circumferential flange.

9. The ear dome according to claim 2, wherein the reinforcement portion is configured to ensure a formation of the concave surface and/or to maintain a curving direction of the concave surface.

10. The ear dome according to claim 1, further comprising a second opening, the second opening being configured to point towards the tympanic membrane when the ear dome is worn by the user.

11. The ear dome according to claim 10, wherein the first circumferential flange is connected at the tubular portion between the first opening and the second opening.

12. The ear dome according to claim 10, wherein the first circumferential flange is closer to the first opening than to the second opening.

13. The ear dome according to claim 10, wherein the first circumferential flange is closer to the second opening than to the first opening.

14. The ear dome according to claim 10, wherein the second opening is at the tubular portion.

15. The ear dome according to claim 10, wherein the second opening is at the concave surface formed by the first circumferential flange.

16. The ear dome according to claim 1, wherein an inner dimension of the concave surface of the first circumferential flange is any from 1 mm to 4 mm, and wherein an outer dimension of the concave surface of the first circumferential flange is anywhere from 6 mm to 12 mm.

17. The ear dome according to claim 1, wherein the ear dome is configured to provide a first sound pressure that is anti-phase with respect to a second sound pressure provided by walls of the ear canal of the user, when the ear dome is worn by the user.

18. The ear dome according to claim 17, wherein the first sound pressure being anti-phase with respect to the second sound pressure is configured to reduce an occlusion effect.

19. A system comprising the ear dome of claim 1 and the hearing device.
